(19) United States
(12) Patent Application Publication
(10) Pub. No.: US 2024/0032147 A1
(43) Pub. Date: Jan. 25, 2024

(54) CONFIGURATION FOR LOGGING MBS MEASUREMENTS

(71) Applicant: Lenovo (Singapore) Pte. Ltd., New Tech Park (SG)

(72) Inventors: Hyung-Nam Choi, Ottobrunn (DE); Joachim Loehr, Wiesbaden (DE); Prateek Basu Mallick, Dreieich (DE); Ravi Kuchibhotla, Chicago, IL (US)

(21) Appl. No.: 18/255,844

(22) PCT Filed: Dec. 2, 2021
(86) PCT No.: PCT/IB2021/061266

§ 371 Date: Jun. 2, 2023

Related U.S. Application Data
(60) Provisional application No. 63/120,641, filed on Dec. 2, 2020.

(51) Int. Cl. H04W 76/40; H04W 76/20; H04W 76/10

(52) U.S. Cl. CPC H04W 76/40; H04W 76/20; H04W 76/10

(57) ABSTRACT

Apparatuses, methods, and systems are disclosed for collecting MBS measurements in a communication network. One apparatus includes a processor and a transceiver that sends a first message to a communication device and receives a second message from the communication device. Here, the first message includes a configuration for logging MBS measurements and the second message includes a set of logged measurement results for at least one MBS service of interest. The processor controls MBS operation in a communication network based on the logged measurement results collected from the communication device.

### CROSS-REFERENCE TO RELATED APPLICATIONS

This application claims priority to U.S. Provisional Patent Application No. 63/120,641 entitled “UE-ASSISTED PROVISIONING OF MULTICAST AND BROADCAST SERVICES” and filed on Dec. 2, 2020 for Hyung-Nam Choi, Joachim Loehr, Prateek Basu Mallick, and Ravi Kuchibhotla, which application is incorporated herein by reference.

### FIELD

The subject matter disclosed herein relates generally to wireless communications and more particularly relates to UE-assisted provisioning of Multicast and Broadcast services.

### BACKGROUND

Some wireless networks support Multimedia Broadcast and Multicast Services (“MBMS”). In MBMS, there are two different kinds of services defined: 1) a broadcast service in which every user can receive the information within the service area and 2) a multicast service in which only users who have subscribed to the service can receive the information. MBMS is a type of Multicast and Broadcast Service (“MBS”).

### BRIEF SUMMARY

Disclosed are procedures for collecting MBS measurements in a communication network. Said procedures may be implemented by apparatus, systems, methods, or computer program products.

One method of a Radio Access Network (“RAN”) for collecting MBS measurements in a communication network includes transmitting a first message to a communication device, where the first message includes a configuration for logging MBS measurements. The method includes receiving a second message from the communication device, said second message comprising a set of logged measurement results for at least one MBS service of interest. The method includes controlling MBS operation in the communication network based on the logged measurement results collected from the communication device.

One method of a User Equipment (“UE”) for collecting MBS measurements in a communication network includes receiving a first message from a communication network, where the first message includes a configuration for logging MBS measurements. The method includes performing MBS measurements for at least one MBS service of interest in accordance with the received configuration and transmitting a second message to the communication network, where the second message includes a set of logged measurement results for the at least one MBS service of interest.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for collecting MBS measurements in a communication network;

FIG. 2A is a block diagram illustrating one embodiment of MBS delivery methods for Multicast services;

FIG. 2B is a block diagram illustrating one embodiment of a UE mobility scenario;

FIG. 3 is a call-flow diagram illustrating one embodiment of dedicated MBS measurements logging and configuration;

FIG. 4 is a call-flow diagram illustrating one embodiment of common MBS measurements logging and configuration;

FIG. 5 is a call-flow diagram illustrating one embodiment of RRC connection establishment for reporting of logged MBS measurements;

FIG. 6 is a diagram illustrating one example of Abstract Syntax Notation 1 (“ASN.1”) code for a RRCSetupRequest message;

FIG. 7 is a diagram illustrating one embodiment of ASN.1 code for a RRCResumeRequest message;

FIG. 8 is a block diagram illustrating one embodiment of a NR protocol stack;

FIG. 9 is a block diagram illustrating one embodiment of a user equipment apparatus that may be used for collecting MBS measurements in a communication network;

FIG. 10 is a block diagram illustrating one embodiment of a network apparatus that may be used for collecting MBS measurements in a communication network;

FIG. 11 is a flowchart diagram illustrating one embodiment of a first method for collecting MBS measurements in a communication network; and

FIG. 12 is a flowchart diagram illustrating one embodiment of a second method for collecting MBS measurements in a communication network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for enabling a network to provide Multicast and Broadcast services to the MBS-capable UEs per PTM delivery method in the respective service areas in accordance with their QoS requirements, e.g., for scenarios where the network has no feedback from the UEs for the received MBS transmissions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For the scenarios where the network has no feedback from the UEs for the received MBS transmissions, solutions are required which enables the network to provide Multicast and Broadcast services to the MIBS-capable UEs per PTM delivery method in the respective service areas in accordance with their QoS requirements. For NR RAT, the DL physical channels may be transmitted carrying the MBS traffic data with a pre-defined, fixed transmit power in accordance with the targeted coverage and QoS. The network can allocate the required transmit power of those MBS physical channels based on, e.g., measurements collected by test equipment and drive tests during network deployment and operation. However, using test equipment and drive tests are costly and not efficient to find out in a timely manner how bad or good the perceived MBS coverage and QoS at a given location is.

Alternatively, users' UEs out in the field can be utilized for automating the collection of measurements in order to minimize the need of conventional drive tests. For this reason, the Minimization of Drive Tests (“MDT”) functionality as specified for NR, E-UTRA (aka “LTE”) and UMTS (i.e., 3G) can be re-used as much as possible to collect measurements for verifying and optimizing MBS coverage and QoS. However, MBS related measurements are not specified yet for MDT in NR.

To support Multicast and Broadcast services, the following solutions may be implemented: A) Dedicated MBS measurements logging configuration; B) Common MBS measurements logging configuration; C) RRC connection establishment or RRC connection resume for MBS purposes. As used herein, “measurement logging” refers to measuring a resource (e.g., an MBS resource) and logging (i.e., recording) measured value(s).

Regarding dedicated MBS measurements logging configuration, the gNB may configure a UE to measure MBS transmissions of MBS sessions in different RRC states using the LoggedMeasurementConfiguration message. The MBS measurements logging configuration may include the following parameters: 1) List of carrier frequencies and cells to perform measurement logging; 2) Candidate MBS sessions to measure; 3) The MBS measurement quantity to measure; 4) The RRC states where the measurements logging is to be performed by the UE; and/or 5) Other information such as logging duration and interval, and location information to correlate the logged measurements and UE position information.

In accordance with the received configuration the UE performs MBS measurements logging in MBS bandwidth part (“BWP”) on carrier frequencies and cells which are used to receive the desired MBS service. The logged measurement results are then reported to the network in the UEInformationResponse message. The UE indicates to the gNB the availability of logged MBS measurements by setting the parameter “ue-MeasurementsAvailableMBS” in the RRCSetupComplete or RRCResumeComplete message.

Regarding common MBS measurements logging configuration, as an alternative or complement to the dedicated MBS measurements logging configuration using the LoggedMeasurementConfiguration message, the gNB may broadcast common MBS measurements logging configuration which are applicable to all MBS-capable UEs located in the current serving cell. This common MBS measurements logging configuration may be broadcast in a new SIB so that the MBS-capable UEs can receive it in all RRC states. The gNB may use both options (dedicated and common MBS measurements logging configuration) at the same time. If this case happens then the dedicated configuration takes precedence over the common configuration.

In addition to the MBS-related measurement parameters as described for the LoggedMeasurementConfiguration message, the common MBS measurements logging configuration may further include a special parameter “UE measurement factor” which indicates a probability value. Based on the “UE measurement factor” the UE determines whether to apply the common MBS measurements logging configuration or not.

Regarding RRC connection establishment or RRC connection resume for MBS purposes, the gNB may broadcast in System Information Block #1 (“SIB1”) a new parameter “mbs-AccessAllowed” to indicate whether an MBS-capable UE is allowed to initiate an RRC connection establishment from RRC_IDLE or an RRC connection resume from RRC_INACTIVE for MBS purposes only. With regards to UAC for initiating RRC connection establishment or RRC connection resume for MBS purpose a new Access Category (“AC”) may be defined or the gNB may broadcast in SIB1 a new parameter “mbs-AC” in conjunction with the parameter “mbs-AccessAllowed” to indicate one of the existing ACs to apply.

A new cause value “mbs-Access” may be included in RRCSetupRequest and RRCResumeRequest/RRCResumeRequest1 message to indicate to the gNB the purpose of RRC connection establishment or RRC connection resumption. With this new cause value, the gNB can decide whether to accept the concerned Request message or not.

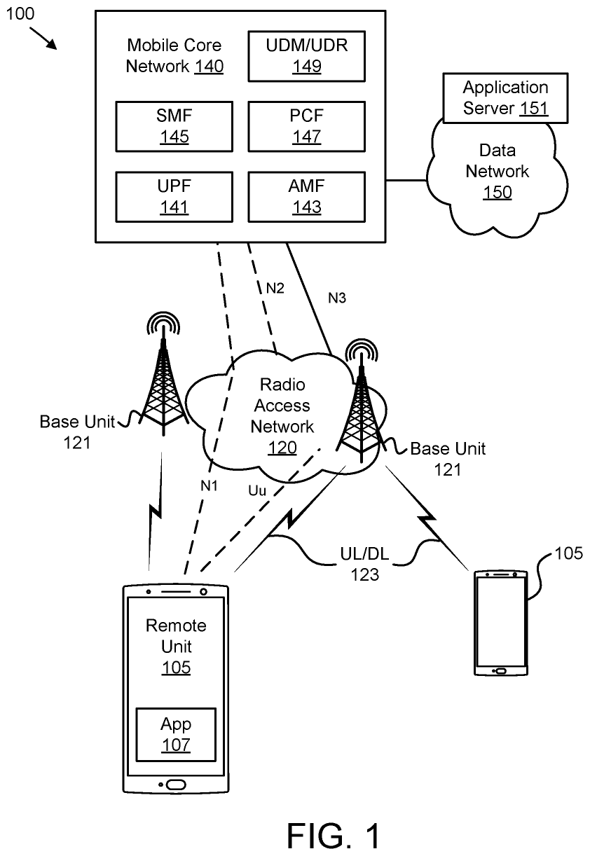

FIG. 1 depicts a wireless communication system 100 for collecting MBS measurements in a communication network, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, abase station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for collecting MBS measurements in a communication network apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), Integrated Access-and-Backhaul (“IAB”) node, Radio Head (“RH”), etc. Additionally, the term “UE” is used for the mobile station/remote unit, but it is replaceable by any other remote device, e.g., remote unit, MS, ME, Customer Premise Equipment (“CPE”), etc. Further, the operations are described mainly in the context of 5G NR. However, the below described solutions/methods are also equally applicable to other mobile communication systems for collecting MBS measurements in a communication network.

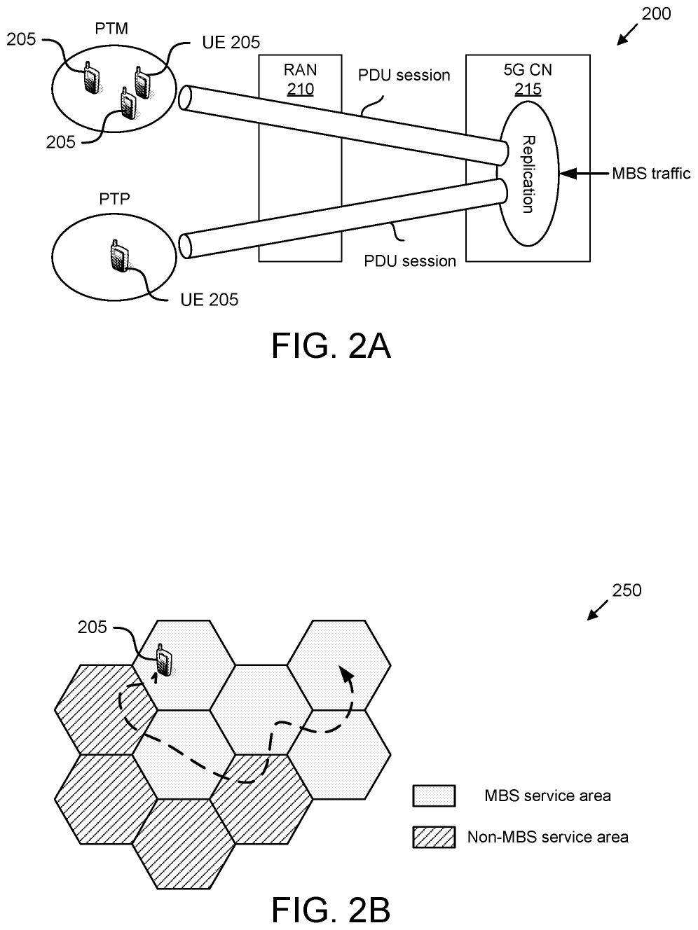

FIG. 2A depicts an MBS delivery implementation 200 for Multicast services, according to embodiments of the disclosure. A key objective of Multicast and Broadcast services (“MBS”) for NR RAT is to support the resource-efficient and reliable transmission of MBS traffic data to multiple UEs in a specific service area at the same time in RAN. In case of Broadcast services, same content of traffic data is to be transmitted to all UEs, whereas in case of Multicast services, same content of traffic data is to be transmitted to a group of UEs located in a specific service area. The targeted applications/services for MBS include:
Internet Protocol Television (“IPTV”)
Linear Television (“TV”)
Radio
Group communications (voice/data/video)
Internet-of-Things (“IoT”) applications
Vehicle-to-Everything (“V2X”) applications
Software delivery

An MBS service area consists of one or multiple cells and MBS traffic data can be delivered in each of those cells either per Point-To-Multipoint (“PTM”) or Point-To-Point (“PTP”) to the UEs 205. In the PTM case, the 5G core network (“CN”) receives a single copy of MBS data packets and delivers the single copy of those MBS packets to RAN, which then delivers them to multiple UEs 205. In the PTP case, the 5G CN receives a single copy of MBS data packets and delivers separate copies of those MBS packets to RAN, which then delivers them to the UE 205 individually.

In general, the use of the MBS delivery methods is dependent on, e.g., type of service (Broadcast or Multicast), the number of MBS-capable UEs located in a service area cell, cell load situation and QoS requirements. For instance, in case of a Multicast service when the cell load is high and there are many MBS-capable UEs located in the cell which are receiving or interested in receiving the concerned Multicast service, the RAN node may decide to deliver traffic data of the Multicast service per PTM to the UEs. Otherwise, the RAN node may decide to deliver traffic data of the Multicast service individually per PTP to the UEs.

Furthermore, with regards to RRC states where MBS traffic data can be received by a UE, it is assumed that the UE needs to be in RRC_CONNECTED for receiving MBS traffic data with high QoS requirements (in terms of reliability and latency), whereas the UE can receive MBS traffic data with low QoS requirements in all RRC states (i.e. RRC_IDLE, RRC_INACTIVE and RRC_CONNECTED). However, definition of high and low QoS requirements has not been made yet and is subject to further discussion.

FIG. 2B depicts a UE mobility scenario 250, according to embodiments of the disclosure. Due to mobility a UE 205 may move across MBS and non-MBS service areas. And discussions in 3GPP recently started how to ensure coverage and QoS of the MBS traffic data received by the UEs in the respective service areas. And referring to the first agreements made on these aspects only RLC UM is supported for PTM transmissions, whereas RLC Acknowledged Mode (“AM”) and Unacknowledged Mode (“UM”) are supported for PTP transmissions. Furthermore, Hybrid Automatic Repeat Request (“HARQ”) is to be supported in RRC_CONNECTED for receiving Multicast services. However, it means that for reception of Multicast and Broadcast services per PTM and in RRC_IDLE/RRC_INACTIVE (and in RRC_CONNECTED as well for reception of Broadcast services), there will be no feedback such as HARQ or RLC acknowledgements to the network, meaning that the network has no knowledge whether MBS transmissions have been successfully received or not by the UEs. Hence, for these scenarios it would be difficult for the network to verify the performance of MBS transmissions.

Disclosed herein are solutions for scenarios where the network has no feedback from the UEs for the received MBS transmissions. These solutions enable the network to provide Multicast and Broadcast services to the MBS-capable UEs per PTM delivery method in the respective service areas in accordance with their QoS requirements.

For the scenarios where the network has no feedback from the UEs for the received MBS transmissions, the following solutions are proposed which enables the network to provide Multicast and Broadcast services to the MBS-capable UEs per PTM delivery method in the respective service areas in accordance with their QoS requirements.

According to embodiments of a first solution, a mobile communication network supports dedicated MBS measurements logging and configuration. In the first solution, it is assumed that an MBS-capable UE has information about forthcoming and ongoing MBS sessions in the current serving cell and neighboring cells. This information may be provided by the network in each cell of the MBS service area per SIB or dedicated message or other means (e.g., application layer signaling). Furthermore, it is assumed that the RAN node knows that the UE is capable of MBS measurements logging. In one embodiment, MBS measurement logging is mandated for an MBS-capable UE. In another embodiment, MBS measurement logging is an optional feature for an MBS-capable UE. Where MBS measurement logging is an optional feature, the RAN node may enable the dedicated MBS measurements logging configuration only if it is supported by the UE.

In various embodiments of the first solution, the mobile communication network uses a dedicated MBS measurements logging configuration. Here, the RAN node may use dedicated signaling to configure a UE to measure MBS transmissions of MBS sessions in different RRC states. With an MBS session, the data transfer of a Multicast or Broadcast service within RAN and CN is performed, as discussed below with reference to FIG. 2A. It is assumed that the data transfer of a Multicast or Broadcast service within RAN and CN is uniquely identified by a NAS MBS session identifier.

In some embodiments, the RAN node sends the MBS measurements logging configuration to the UE using the LoggedMeasurementConfiguration message. The MBS measurements logging configuration may include the following MBS-related measurement parameters:
List of carrier frequencies and cells to perform measurement logging
Candidate MBS sessions to measure (i.e., Option 1, Option 2, or Option 3, below)
The MBS measurement quantity to measure, e.g., MBS Reference Signal Received Power (“RSRP”), MBS Reference Signal Received Quality (“RSRQ”), MBS Block Error Rate (“BLER”)
The RRC states where the measurements logging is to be performed by the UE. The configuration may include the following options: {RRC_IDLE, RRC_INACTIVE, RRC_IDLE and RRC_INACTIVE, RRC_CONNECTED, All RRC states}
Logging duration and interval, and location information to correlate the logged measurements and UE position information

Regarding which candidate MBS sessions to measure:

According to Option 1, the candidate MBS session(s) are selected by the RAN node based on its interest. In this case, the RAN node provides an explicit list of candidate MBS sessions, and the UE performs measurement logging only for those listed MBS sessions it actually receives.

According to Option 2, the candidate MBS session(s) are selected by UE based on its interest. That means, no explicit list of candidate MBS sessions is provided by the RAN node and the UE performs measurement logging only for the MBS sessions it actually receives.

According to Option 3, the Options 1 and 2 are combined, where the RAN node provides an explicit list of candidate MBS sessions, and the UE performs measurement logging only for the MBS sessions it actually receives. As result, according to Option 3 the logged measurements may or may not include MBS sessions which were given by the explicit list.

In accordance with the received configuration, the UE performs MBS measurements. In some embodiments, the UE tunes to (e.g., switches to) an MBS BWP on carrier frequencies and cells which are used to receive the desired MBS service and logs MBS measurements. The logged measurement results are then reported to the network, e.g., in an UEInformationResponse message. The reported measurement logs may be provided by the UE in the following format.

For each measured cell, report:
Global cell identity
Carrier frequency
Location information
RRC state
Measurement results for each received MBS session (MBS RSRP, MBS RSRQ, MBS BLER)

In some embodiments, the UE indicates to the RAN node the availability of logged MBS measurements by setting the parameter “ue-MeasurementsAvailableMBS” in the RRCSetupComplete or RRCResumeComplete message.

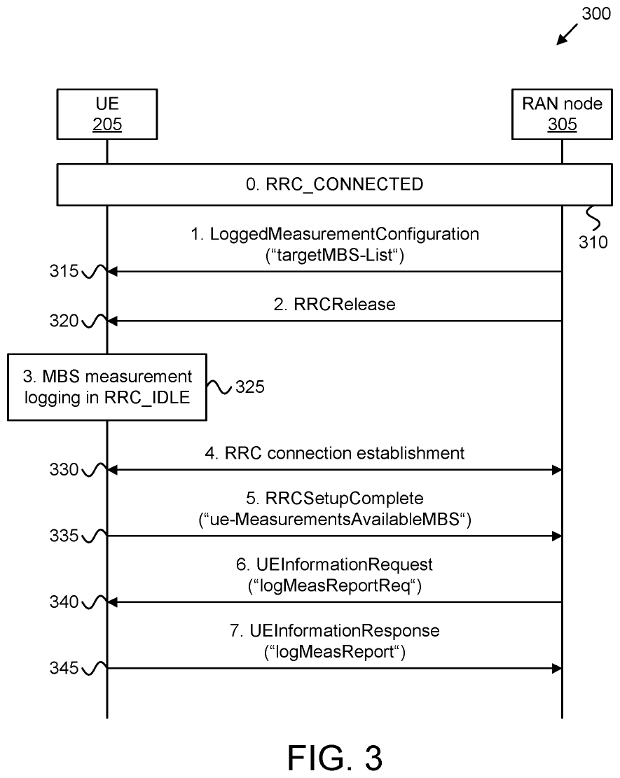

FIG. 3 depicts an exemplary message flow of a procedure 300 for dedicated MBS measurements logging configuration, according to embodiments of the first solution. The procedure 300 involves an MBS-capable UE 205, which may be one embodiment of the remote unit 105, and a RAN node 305, which may be a gNB and/or an embodiment of the base unit 121.

At Step 0, the UE 205 enters the RRC_CONNECTED state in the RAN containing the RAN node 305 (see block 310).

At Step 1, the UE 205 receives from the RAN node 305 the message LoggedMeasurementConfiguration which contains the configuration to perform logging of MBS measurements (see dedicated signaling 315). In various embodiments, the UE 205 receives the configuration per “targetMBS-List” including the following parameter settings:
A list of carrier frequencies and cells to perform measurement logging, e.g., on carrier frequency F1 the cells (a1, a2, a3) and on carrier frequency F2 the cells (b1, b2)
A list of candidate MBS sessions, e.g., (MBS session ID #1, MBS session ID #2, MBS session ID #3, MBS session ID #4)
The MBS measurement quantity to measure for each session: MBS RSRP, MBS RSRQ, MBS BLER
The RRC states where the measurements logging is to be performed by the UE 205 (e.g., the RRC_IDLE state)
Other information such as logging duration and interval, and location information

At Step 2, while the UE 205 has not started yet reception of MBS sessions of interest in RRC_CONNECTED, the UE 205 receives from the RAN node 305 an RRCRelease message (see messaging 320). Upon receiving the RRCRelease message, the UE 205 transitions to a non-connected mode, such as the RRC_IDLE state.

At Step 3, while in the RRC_IDLE state, the UE 205 starts reception of MBS sessions of interest (e.g., MBS session ID #1 and MBS session ID #3) and performs MBS measurements logging for those sessions in accordance with dedicated configuration received in the LoggedMeasurementConfiguration message (see block 325). While the embodiments of FIG. 3 show the UE 205 performing MBS measurement logging while in the RRC_IDLE state, in other embodiments the UE 205 may perform MBS measurement logging while in the RRC_INACTIVE state.

At Step 4, the UE 205 has completed the MBS measurements logging and wants to report the logged measurement results to the RAN node 305. Furthermore, the AS layer/entity in the UE 205 receives from the NAS layer a trigger to perform the RRC connection establishment procedure to initiate the NAS Registration Area update procedure (see messaging 330).

At Step 5, the UE 205 includes the parameter “ue-MeasurementsAvailableMBS” in the RRCSetupComplete message to indicate to the RAN node 305 that it has logged MBS measurements available (see messaging 335).

At Step 6, based on the received information/parameter, the RAN node 305 sends a UEInformationRequest message to the UE 205 to request that the UE 205 report the logged MBS measurements (see messaging 340).

At Step 7, the UE 205 transmits the UEInformationResponse message to the RAN node 305 including the logged MBS measurements, e.g., for MBS session ID #1 and MBS session ID #3, as part of the parameter “logMeasReport” (see messaging 345).

With the logged MBS measurements (e.g., collected from multiple UEs), the RAN node 305 is enabled to verify the performance of MBS transmission and can reconfigure the MBS service areas and MBS operation parameters, if needed.

According to embodiments of a second solution, a mobile communication network supports common MBS measurements logging and configuration. In the second solution, it is assumed that an MBS-capable UE has information about forthcoming and ongoing MBS sessions in the current serving cell and neighboring cells. This information may be provided by the network in each cell of the MBS service area per SIB, as described in greater detail below. Furthermore, it is assumed that the RAN node knows that the UE is capable of MBS measurements logging. In one embodiment, MBS measurement logging is mandated for an MBS-capable UE. In another embodiment, MBS measurement logging is an optional feature for an MBS-capable UE. Where MBS measurement logging is an optional feature, the RAN node may enable the dedicated MBS measurements logging configuration only if it is supported by the UE.

In various embodiments of the second solution, the mobile communication network uses a common MBS measurements logging configuration. Here, the RAN node may use system information to configure a UE to measure MBS transmissions of MBS sessions in different RRC states. With an MBS session, the data transfer of a Multicast or Broadcast service within RAN and CN is performed, as discussed above with reference to FIG. 2A. It is assumed that the data transfer of a Multicast or Broadcast service within RAN and CN is uniquely identified by a NAS MBS session identifier.

Note that the common MBS measurements logging configuration may be used to complement the dedicated MBS measurements logging configuration. For example, the RAN node may broadcast a common MBS measurements logging configuration which is applicable to all MBS-capable UEs located in the current serving cell. This common MBS measurements logging configuration may be broadcast in a new SIB so that the MBS-capable UEs can receive it in all RRC states.

In certain embodiments, the RAN node may use both dedicated and common MBS measurements logging configuration at the same time, where the dedicated configuration takes precedence over the common configuration. In other words, an MBS-capable UE receives the broadcast common MBS measurement logging configuration and applies the common configuration unless and until the MBS-capable UE receives a dedicated configuration from the RAN node. If received, this dedicated MBS measurement logging configuration replaces the common MBS measurement logging configuration.

In some embodiments, the common MBS measurement logging configuration includes the MBS-related measurement parameters as contained in the LoggedMeasurementConfiguration message, described above. In addition, the common MBS measurements logging configuration may further include a special parameter “UE measurement factor” which indicates a probability value, e.g., in the range {p10, p25, p50, p75, p90}. If this parameter is present an MBS-capable UE draws a random number uniformly distributed in the range 0≤random number<1. If the random number is lower than the value indicated by “UE measurement factor” then the UE applies the common MBS measurements logging configuration, otherwise the UE ignores the common MBS measurements logging configuration.

In accordance with the received configuration(s), the UE performs MBS measurements. In some embodiments, the UE tunes to (e.g., switches to) an MBS BWP on carrier frequencies and cells which are used to receive the desired MBS service and logs MBS measurements.

The logged measurement results are then reported to the network, e.g., in an UEInformationResponse message. In some embodiments, the UE indicates to the RAN node the availability of logged MBS measurements in RRC signaling by setting the parameter “ue-MeasurementsAvailableMBS.” With the logged MBS measurements (e.g., collected from multiple UEs), the RAN node is enabled to verify the performance of MBS transmission and can reconfigure the MBS service areas and MBS operation parameters, if needed.

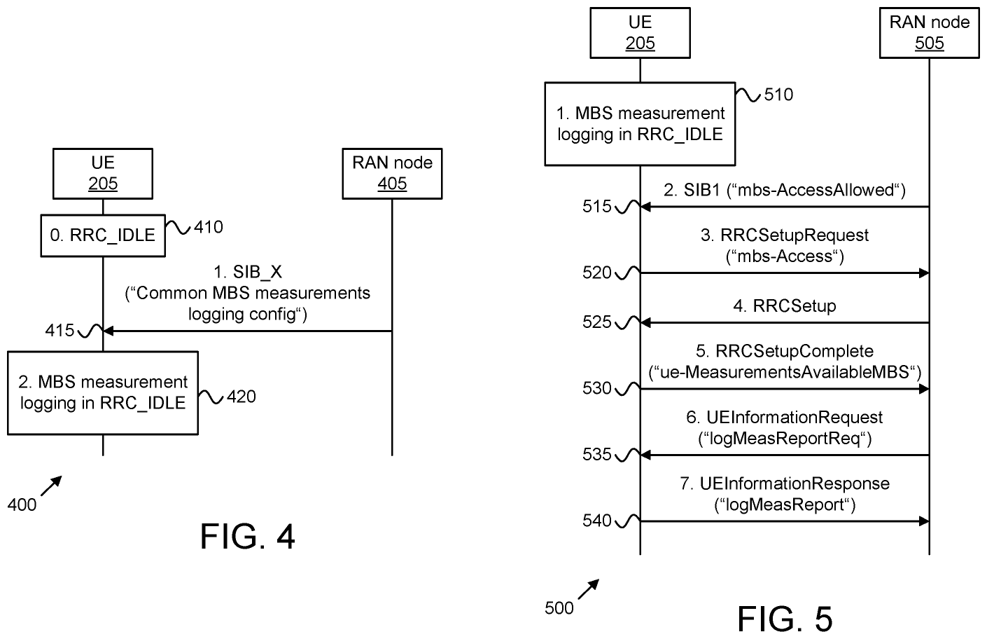

FIG. 4 depicts an exemplary message flow of a procedure 400 for common MBS measurements logging configuration, according to embodiments of the second solution. The procedure 400 involves the MBS-capable UE 205, which may be an embodiment of the remote unit 105, and a RAN node 405, which may be a gNB and/or an embodiment of the base unit 121.

At Step 0, the MBS-capable UE 205 enters the RRC_IDLE state (see block 410). In various embodiments, the UE 205 also receives MBS sessions it is interested in (e.g., MBS session ID #1 and MBS session ID #3) while in the RRC_IDLE state. While the embodiments of FIG. 4 show the UE 205 performing MBS measurement logging while in the RRC_IDLE state, in other embodiments the UE 205 may perform MBS measurement logging while in the RRC_INACTIVE state.

At Step 1, in anew SIB (denoted “SIB_X”) the UE 205 receives the common MBS measurements logging configuration (see broadcast signaling 415). Regarding the applicability of the received common MBS measurements logging configuration from SIB_X, it is assumed that the UE 205 generates a random number that is lower than the value indicated by “UE measurement factor.” In one example, the configuration the parameter “UE measurement factor” is set to a probability value of ‘p25’ and the UE 205 generates a random number of ‘0.1’ that is lower than the value indicated by “UE measurement factor.” Therefore, the UE 205 applies the received common MBS measurements logging configuration from SIB_X.

In various embodiments, the common MBS measurements logging configuration includes the following parameters:
A list of carrier frequencies and cells to perform measurement logging, e.g., on carrier frequency F1 the cells (a1, a2, a3) and on carrier frequency F2 the cells (b1, b2)
A list of candidate MBS sessions, e.g., (MBS session ID #1, MBS session ID #2, MBS session ID #3, MBS session ID #4)
The MBS measurement quantity to measure for each session: MBS RSRP, MBS RSRQ, MBS BLER
The RRC states where the measurements logging is to be performed by the UE 205 (e.g., RRC_IDLE)
Other information such as logging duration and interval, and location information

At Step 2, the UE 205 performs MBS measurements logging for the MBS sessions it actually receives, e.g., MBS session ID #1 and MBS session ID #3 (see block 420). Note that after completing the MBS measurements logging, the UE 205 may report the logged MBS measurements, for example according to the third solution.

According to embodiments of a third solution, a mobile communication network uses RRC connection establishment or RRC connection resume for MBS purposes, e.g., for reporting of logged MBS measurements. In some embodiments, a RAN node may broadcast in SIB1 a new parameter “mbs-AccessAllowed” to indicate whether an MBS-capable UE is allowed to initiate an RRC connection establishment from RRC_IDLE or an RRC connection resume from RRC_INACTIVE for MBS purposes only.

With regards to Unified Access Control (“UAC”) for initiating RRC connection establishment or RRC connection resumption for MBS purpose, a new Access Category (“AC”) may be defined, e.g., AC #11.Alternatively, the RAN node may broadcast in SIB1 a new parameter, denoted “mbs-AC,” in conjunction with the parameter “mbs-AccessAllowed” to indicate one of the existing ACs to apply, e.g., AC #6 that is currently used for Short Message Service (“SMS”).

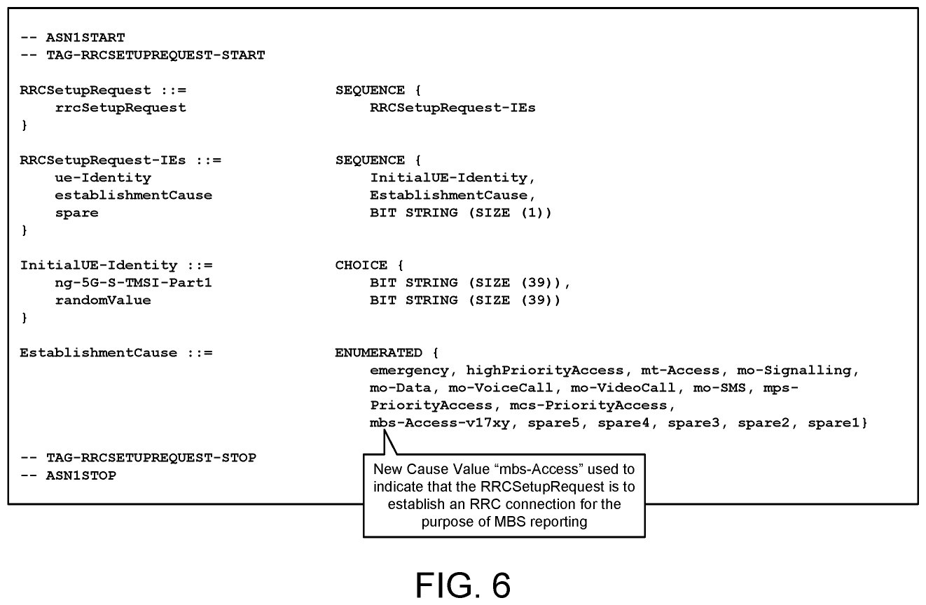

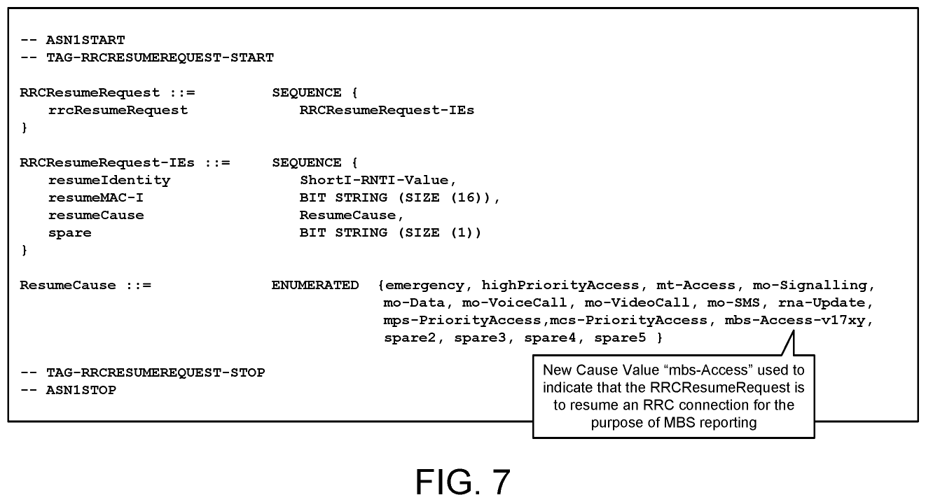

In various embodiments, a new cause value, denoted “mbs-Access,” is introduced in RRCSetupRequest and RRCResumeRequest RRCResumeRequest1 messages to indicate to the RAN nodes the purpose of RRC connection establishment or RRC connection resume, as depicted in FIGS. 6 and 7. With this new cause value, the RAN node can decide whether to accept the concerned Request message or not. For instance, the RAN node may decide to reject the concerned Request message in case of high cell load.

FIG. 5 depicts exemplary message flow of a procedure 500 for RRC connection establishment for reporting of logged MBS measurements, according to embodiments of the third solution. The procedure 500 involves the MBS-capable UE 205 and a RAN node 505, which may be a gNB and/or an embodiment of the base unit 121.

In the procedure 500, it is assumed that the UE 205 is in RRC_IDLE and has been enabled for MBS measurements logging by the RAN node 505, either per dedicated LoggedMeasurementConfiguration message when it was previously in RRC_CONNECTED (as described in the first solution) or per broadcast common MBS measurements logging configuration (as described in the second solution). Furthermore, it is assumed that a new AC, denoted ‘AC #11,’ has been defined for access control of RRC connection establishments for the purpose of MBS reporting.

At Step 1, the UE 205 performs MBS measurements logging for the MBS sessions it is interested in (see block 510). Here, it is assumed that the UE 205 is interested in MBS session ID #1 and MBS session ID #3.

At Step 2, the MBS measurements logging has been completed and the UE 205 wants to report the logged measurement results to the RAN node 505. However, there is currently no trigger from the NAS layer of the UE 205 to initiate RRC connection establishment, e.g., for NAS Registration Area update procedure. Therefore, the UE 205 checks SIB1 from the current serving cell whether the parameter “mbs-AccessAllowed” is set or not (see messaging 515). Here, it is assumed that the parameter “mbs-AccessAllowed” is set and therefore the UE 205 is permitted to establish/resume an RRC connection for the purpose of MBS reporting.

At Step 3, after performing access control based on new AC #11,the UE 205 sends the RRCSetupRequest message including the value “mbs-Access” in the EstablishmentCause parameter, which value indicates to the RAN node 505 that the purpose of RRC connection establishment is due to MBS (see messaging 520).

At Step 4, the RAN node 505 accepts the RRCSetupRequest message and sends as a response the RRCSetup message to the UE 205 to establish a signaling radio bearer (“SRB”), denoted “SRB1” (see messaging 525).

At Step 5, the UE 205 includes the parameter “ue-MeasurementsAvailableMBS” in the RRCSetupComplete message to indicate to the RAN node 505 that it has logged MBS measurements available (see messaging 530).

At Step 6, based on the received information/parameter, the RAN node 505 sends a UEInformationRequest message to the UE 205 to request that the UE 205 report the logged MBS measurements (see messaging 535).

At Step 7, the UE 205 transmits the UEInformationResponse message to the RAN node 505 including the logged MBS measurements, e.g., for MBS session ID #1 and MBS session ID #3, as part of the parameter “logMeasReport” (see messaging 540).

FIG. 6 depicts ASN.1 code for a RRCSetupRequest message, according to embodiments of the disclosure. Here, the RRCSetupRequest message is modified to include a new cause value in the parameter EstablishmentCause. As depicted, a new cause value “mbs-Access” is introduced to indicate to the RAN node the purpose of establishing an RRC connection establishment.

With this new cause value “mbs-Access,” the RAN node can decide whether to accept the concerned Request message or not. For instance, the RAN node may decide to reject the concerned Request message in case of high cell load.

FIG. 7 depicts ASN.1 code for a RRCResumeRequest message, according to embodiments of the disclosure. Here, the RRCResumeRequest message is modified to include a new cause value in the parameter ResumeCause. As depicted, a new cause value “mbs-Access” is introduced in RRCResumeRequest message to indicate to RAN node the purpose of resuming an RRC connection. While FIG. 6 depicts a RRCResumeRequest message, similar changes may be made to a RRCResumeRequest1 message.

With this new cause value “mbs-Access,” the RAN node can decide whether to accept the concerned Request message or not. For instance, the RAN node may decide to reject the concerned Request message in case of high cell load.

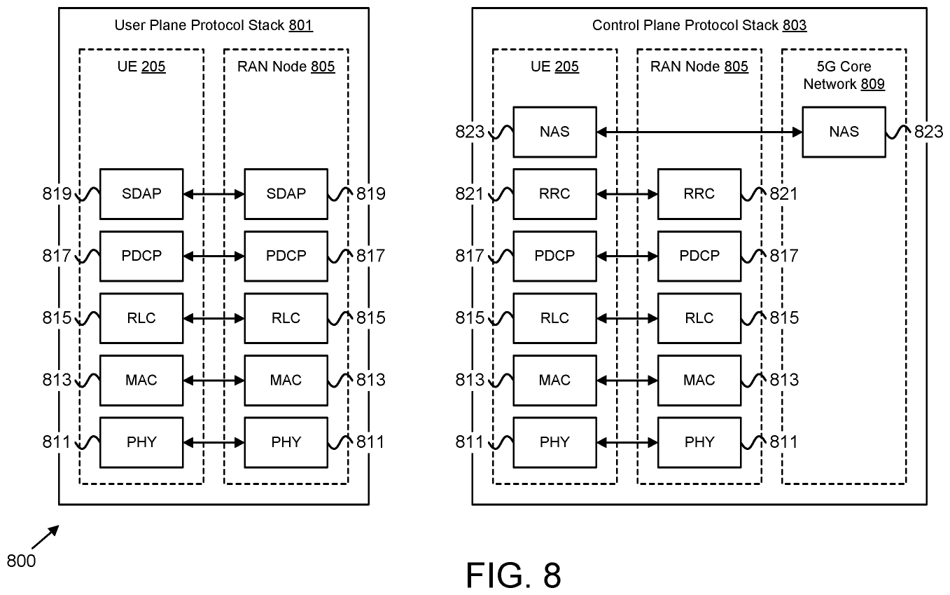

FIG. 8 depicts a protocol stack 800, according to embodiments of the disclosure. While FIG. 8 shows a UE 205, a RAN node 805 (e.g., one of the RAN nodes 305, 405 or 505) and the 5G core network 809, these are representative of a set of remote units 105 interacting with a base unit 121 and a mobile core network 140. As depicted, the protocol stack 800 comprises a User Plane protocol stack 801 and a Control Plane protocol stack 803. The User Plane protocol stack 801 includes a physical (“PHY”) layer 811, a Medium Access Control (“MAC”) sublayer 813, the Radio Link Control (“RLC”) sublayer 815, a Packet Data Convergence Protocol (“PDCP”) sublayer 817, and Service Data Adaptation Protocol (“SDAP”) layer 819. The Control Plane protocol stack 803 includes a physical layer 811, a MAC sublayer 813, a RLC sublayer 815, and a PDCP sublayer 817. The Control Place protocol stack 803 also includes a Radio Resource Control (“RRC”) layer 821 and a Non-Access Stratum (“NAS”) layer 823.

The AS layer (also referred to as “AS protocol stack”) for the User Plane protocol stack 801 consists of at least SDAP, PDCP, RLC and MAC sublayers, and the physical layer. The AS layer for the Control Plane protocol stack 803 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 821 and the NAS layer 823 for the control plane and includes, e.g., an Internet Protocol (“IP”) layer or PDU Layer (not depicted) for the user plane. L1 and L2 are referred to as “lower layers,” while L3 and above (e.g., transport layer, application layer) are referred to as “higher layers” or “upper layers.”

The physical layer 811 offers transport channels to the MAC sublayer 813. The MAC sublayer 813 offers logical channels to the RLC sublayer 815. The RLC sublayer 815 offers RLC channels to the PDCP sublayer 817. The PDCP sublayer 817 offers radio bearers to the SDAP sublayer 819 and/or RRC layer 821. The SDAP sublayer 819 offers QoS flows to the core network (e.g., 5GC 809). The RRC layer 821 provides for the addition, modification, and release of Carrier Aggregation and/or Dual Connectivity. The RRC layer 821 also manages the establishment, configuration, maintenance, and release of Signaling Radio Bearers (“SRBs”) and Data Radio Bearers (“DRBs”).

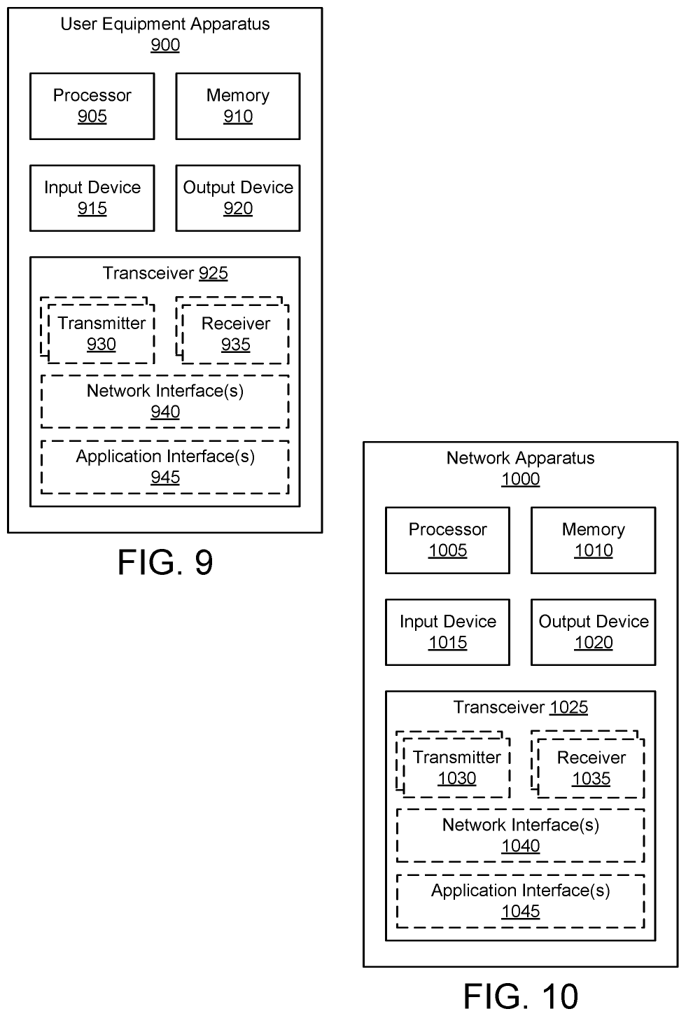

FIG. 9 depicts a user equipment apparatus 900 that may be used for collecting MBS measurements in a communication network, according to embodiments of the disclosure. In various embodiments, the user equipment apparatus 900 is used to implement one or more of the solutions described above. The user equipment apparatus 900 may be one embodiment of the remote unit 105 and/or the UE 205, described above. Furthermore, the user equipment apparatus 900 may include a processor 905, a memory 910, an input device 915, an output device 920, and a transceiver 925.

In some embodiments, the input device 915 and the output device 920 are combined into a single device, such as a touchscreen. In certain embodiments, the user equipment apparatus 900 may not include any input device 915 and/or output device 920. In various embodiments, the user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. In some embodiments, the transceiver 925 communicates with one or more cells (or wireless coverage areas) supported by one or more base units 121. In various embodiments, the transceiver 925 is operable on unlicensed spectrum. Moreover, the transceiver 925 may include multiple UE panels supporting one or more beams. Additionally, the transceiver 925 may support at least one network interface 940 and/or application interface 945. The application interface(s) 945 may support one or more APIs. The network interface(s) 940 may support 3GPP reference points, such as Uu, N1, PC5, etc. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the processor 905 controls the user equipment apparatus 900 to implement the above described UE behaviors. In certain embodiments, the processor 905 may include an application processor (also known as “main processor”) which manages application-domain and operating system (“OS”) functions and a baseband processor (also known as “baseband radio processor”) which manages radio functions.

In various embodiments, the processor 905 controls the transceiver 925 to receive (i.e., via an air/radio interface) a first message from a communication network, where the first message includes a configuration for logging MBS measurements. The processor performs MBS measurements for at least one MBS service of interest in accordance with the received configuration and the transceiver sends a second message to the communication network, where the second message includes a set of logged measurement results for the at least one MBS service of interest. As used herein, “logging MBS measurement” refers to measuring a resource (e.g., a carrier frequency for MBS service) and logging (i.e., recording) measured value(s).

In some embodiments, when performing the MBS measurements, the processor 905 switches to an MBS BWP on carrier frequencies and cells which are used to receive the at least one MBS service of interest. In some embodiments, the transceiver 925 receives the first message by receiving a system information message that is broadcast by the communication network, where the configuration for logging MBS measurements contains a common configuration. In such embodiments, the processor 905 determines whether to apply the received configuration.

In some embodiments, the processor 905 receives an indication from the communication network that allows initiation of RRC connection establishment and/or RRC connection resume for MBS measurement reporting. In such embodiments, transmitting the second message includes either establishing an RRC connection for reporting the set of logged measurement results or resuming an RRC connection for reporting the set of logged measurement results.

In certain embodiments, establishing the RRC connection for reporting the set of logged measurement results includes transmitting a setup request message containing a cause value that indicates that the RRC connection is to be established for MBS access. In certain embodiments, resuming the RRC connection for reporting the set of logged measurement results includes transmitting a resume request message containing a cause value that indicates that the RRC connection is to be resumed for MBS access.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to collecting MBS measurements in a communication network and/or mobile operation. For example, the memory 910 may store various parameters, panel/beam configurations, resource assignments, policies, and the like as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 communicates with one or more network functions of a mobile communication network via one or more access networks. The transceiver 925 operates under the control of the processor 905 to transmit messages, data, and other signals and also to receive messages, data, and other signals. For example, the processor 905 may selectively activate the transceiver 925 (or portions thereof) at particular times in order to send and receive messages.

The transceiver 925 includes at least transmitter 930 and at least one receiver 935. One or more transmitters 930 may be used to provide UL communication signals to a base unit 121, such as the UL transmissions described herein. Similarly, one or more receivers 935 may be used to receive DL communication signals from the base unit 121, as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

In various embodiments, one or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one more common control signals or as modular transmitters 930 and receivers 935 implemented in the same hardware chip or in a multi-chip module.

FIG. 10 depicts a network apparatus 1000 that may be used for collecting MBS measurements in a communication network, according to embodiments of the disclosure. In one embodiment, network apparatus 1000 may be one implementation of a RAN entity used to implement one or more of the above solutions. The network apparatus 1000 may be one embodiment of the base unit 121, the RAN node 305, the RAN node 405, the RAN node 505, the RAN node 805, and/or a gNB, as described above. Furthermore, the network apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the network apparatus 1000 may not include any input device 1015 and/or output device 1020. In various embodiments, the network apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. Here, the transceiver 1025 communicates with one or more remote units 105. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2 and N3. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a CPU, a GPU, an auxiliary processing unit, a FPGA, or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the network apparatus 1000 is a RAN node (e.g., gNB) that communicates with one or more UEs, as described herein. In such embodiments, the processor 1005 controls the network apparatus 1000 to perform the above described RAN behaviors. When operating as a RAN node, the processor 1005 may include an application processor (also known as “main processor”) which manages application-domain and operating system (“OS”) functions and a baseband processor (also known as “baseband radio processor”) which manages radio functions.

In various embodiments, the processor 1005 controls the transceiver 1025 to send a first message to a communication device (i.e., a UE) and receive a second message from the communication device. Here, the first message includes a configuration for logging MBS measurements and the second message includes a set of logged measurement results for at least one MBS service of interest. The processor 1005 controls MBS operation in the communication network based on the logged measurement results collected from the communication device. Examples of controlling MBS operation include, but are not limited to, selecting or switching a traffic delivery mechanism (i.e., PTM or PTP), modifying transmit power for MBS, reconfiguring MBS service areas, and modifying delivery resources to meet QoS requirements.

In some embodiments, the first message is a dedicated message sent to the communication device while in a connected mode (e.g., the RRC_CONNECTED state). In some embodiments, the first message is broadcast to the communication device in system information. In such embodiments, the configuration for logging MBS measurements may include a common configuration.

In some embodiments, the configuration for logging MBS measurements includes one or more of: a list of carrier frequencies and cells to measure, a BWP to use for MBS measurement, a list of candidate MBS sessions to measure, a type of MBS measurement, an RRC state in which MBS measurement is to be performed, a logging duration, a logging interval, and a location requirement. In some embodiments, the processor 1005 sends an indication to the communication device that allows establishing an RRC connection for MBS access and/or allows resuming an RRC connection for MBS access.

In some embodiments, receiving the second message includes receiving a request message and either establishing an RRC connection for reporting the set of logged measurement results or resuming an RRC connection for reporting the set of logged measurement results. In certain embodiments, establishing the RRC connection for reporting the set of logged measurement results includes receiving a setup request message containing a cause value that indicates that the RRC connection is to be established for MBS access. In certain embodiments, resuming the RRC connection for reporting the set of logged measurement results includes receiving a resume request message containing a cause value that indicates that the RRC connection is to be resumed for MBS access.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to collecting MBS measurements in a communication network and/or mobile operation. For example, the memory 1010 may store parameters, configurations, resource assignments, policies, and the like, as described above. In certain embodiments, the memory 1010 also stores program code and related data, such as an operating system or other controller algorithms operating on the apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the network apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 includes at least transmitter 1030 and at least one receiver 1035. One or more transmitters 1030 may be used to communicate with the UE, as described herein. Similarly, one or more receivers 1035 may be used to communicate with network functions in the Public Land Mobile Network (“PLMN”) and/or RAN, as described herein. Although only one transmitter 1030 and one receiver 1035 are illustrated, the network apparatus 1000 may have any suitable number of transmitters 1030 and receivers 1035. Further, the transmitter(s) 1030 and the receiver(s) 1035 may be any suitable type of transmitters and receivers.

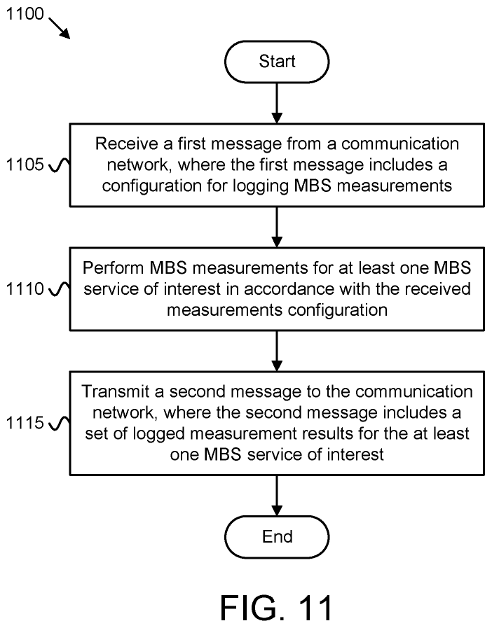

FIG. 11 depicts one embodiment of a method 1100 for collecting MBS measurements in a communication network, according to embodiments of the disclosure. In various embodiments, the method 1100 is performed by a UE device, such as the remote unit 105, the UE 205, and/or the user equipment apparatus 900, as described above. In some embodiments, the method 1100 is performed by a processor, such as a microcontroller, a microprocessor, a CPU, a GPU, an auxiliary processing unit, a FPGA, or the like.

The method 1100 begins and receives 1105 a first message from a communication network, where the first message includes a configuration for logging MBS measurements. The method 1100 includes performing 1110 MBS measurements for at least one MBS service of interest in accordance with the received configuration. The method 1100 includes transmitting 1115 a second message to the communication network, where the second message includes a set of logged measurement results for the at least one MBS service of interest. The method 1100 ends.

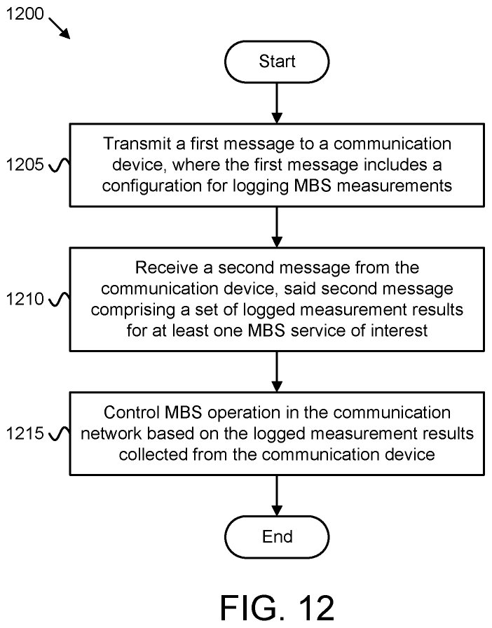

FIG. 12 depicts one embodiment of a method 1200 for collecting MBS measurements in a communication network, according to embodiments of the disclosure. In various embodiments, the method 1200 is performed by a RAN entity, such as the base unit 121, the RAN node 305, the RAN node 405, the RAN node 505, the RAN node 805, a gNB and/or the network apparatus 1000, as described above. In some embodiments, the method 1200 is performed by a processor, such as a microcontroller, a microprocessor, a CPU, a GPU, an auxiliary processing unit, a FPGA, or the like.

The method 1200 begins and transmits 1205 a first message to a communication device (i.e., UE), where the first message includes a configuration for logging MBS measurements. The method 1200 includes receiving 1210 a second message from the communication device, said second message comprising a set of logged measurement results for at least one MBS service of interest. The method 1200 includes controlling 1215 MBS operation in the communication network based on the logged measurement results collected from the communication device. The method 1200 ends.

Disclosed herein is a first apparatus for collecting MBS measurements in a communication network, according to embodiments of the disclosure. The first apparatus may be implemented by a RAN entity, such as the base unit 121, the RAN node 305, the RAN node 405, the RAN node 505, the RAN node 805, and/or the network apparatus 1000, described above. The first apparatus includes a processor and a transceiver that sends a first message to a communication device (i.e., UE) and receives a second message from the communication device. Here, the first message includes a configuration for logging MBS measurements and the second message includes a set of logged measurement results for at least one MBS service of interest. The processor controls MBS operation in the communication network based on the logged measurement results collected from the communication device.

In some embodiments, the first message is a dedicated message sent to the communication device while in a connected mode (e.g., the RRC_CONNECTED state). In some embodiments, the first message is broadcast to the communication device in system information. In such embodiments, the configuration for logging MBS measurements may include a common configuration.

In some embodiments, the configuration for logging MBS measurements includes one or more of: a list of carrier frequencies and cells to measure, a BWP to use for MBS measurement, a list of candidate MBS sessions to measure, a type of MBS measurement, an RRC state in which MBS measurement is to be performed, a logging duration, a logging interval, and a location requirement. In some embodiments, the processor transmits an indication to the communication device that allows establishing an RRC connection for MBS access and/or allows resuming an RRC connection for MBS access.

In some embodiments, receiving the second message includes receiving a request message and either establishing an RRC connection for reporting the set of logged measurement results or resuming an RRC connection for reporting the set of logged measurement results. In certain embodiments, establishing the RRC connection for reporting the set of logged measurement results includes receiving a setup request message containing a cause value that indicates that the RRC connection is to be established for MBS access. In certain embodiments, resuming the RRC connection for reporting the set of logged measurement results includes receiving a resume request message containing a cause value that indicates that the RRC connection is to be resumed for MBS access.

Disclosed herein is a first method for collecting MBS measurements in a communication network, according to embodiments of the disclosure. The first method may be performed by a RAN entity, such as the base unit 121, the RAN node 305, the RAN node 405, the RAN node 505, the RAN node 805, and/or the network apparatus 1000, described above. The first method includes transmitting a first message to a communication device (i.e., UE), where the first message includes a configuration for logging MBS measurements. The first method includes receiving a second message from the communication device, said second message comprising a set of logged measurement results for at least one MBS service of interest. The first method includes controlling MBS operation in the communication network based on the logged measurement results collected from the communication device.

In some embodiments, the first message is a dedicated message sent to the communication device while in a connected mode (e.g., the RRC_CONNECTED state). In some embodiments, the first message is broadcast to the communication device in system information. In such embodiments, the configuration for logging MBS measurements may include a common configuration.

In some embodiments, the configuration for logging MBS measurements includes one or more of: a list of carrier frequencies and cells to measure, a BWP to use for MBS measurement, a list of candidate MBS sessions to measure, a type of MBS measurement, an RRC state in which MBS measurement is to be performed, a logging duration, a logging interval, and a location requirement. In some embodiments, the first method includes transmitting an indication to the communication device that allows establishing an RRC connection for MBS access and/or allows resuming an RRC connection for MBS access.

In some embodiments, receiving the second message includes receiving a request message and either establishing an RRC connection for reporting the set of logged measurement results or resuming an RRC connection for reporting the set of logged measurement results. In certain embodiments, establishing the RRC connection for reporting the set of logged measurement results includes receiving a setup request message containing a cause value that indicates that the RRC connection is to be established for MBS access. In certain embodiments, resuming the RRC connection for reporting the set of logged measurement results includes receiving a resume request message containing a cause value that indicates that the RRC connection is to be resumed for MBS access.

Disclosed herein is a second apparatus for collecting MBS measurements in a communication network, according to embodiments of the disclosure. The second apparatus may be implemented by a UE device, such as the remote unit 105, the UE 205, and/or the user equipment apparatus 900, described above. The second apparatus includes a processor and a transceiver that receives a first message from a communication network, where the first message includes a configuration for logging MBS measurements. The processor performs MBS measurements for at least one MBS service of interest in accordance with the received configuration and the transceiver sends a second message to the communication network, where the second message includes a set of logged measurement results for the at least one MBS service of interest.

In some embodiments, performing the MBS measurements comprises switching to an MBS BWP on carrier frequencies and cells which are used to receive the at least one MBS service of interest. In some embodiments, the first message is broadcast by the communication network in system information, where the configuration for logging MBS measurements contains a common configuration. In such embodiments, the processor determines whether to apply the received configuration.

In some embodiments, the processor receives an indication from the communication network that allows initiation of RRC connection establishment and/or RRC connection resume for MBS measurement reporting. In such embodiments, transmitting the second message includes establishing an RRC connection for reporting the set of logged measurement results or resuming an RRC connection for reporting the set of logged measurement results.

In certain embodiments, establishing the RRC connection for reporting the set of logged measurement results includes transmitting a setup request message containing a cause value that indicates that the RRC connection is to be established for MBS access. In certain embodiments, resuming the RRC connection for reporting the set of logged measurement results includes transmitting a resume request message containing a cause value that indicates that the RRC connection is to be resumed for MBS access.

Disclosed herein is a second method for collecting MBS measurements in a communication network, according to embodiments of the disclosure. The second method may be performed by a UE device, such as the remote unit 105, the UE 205, and/or the user equipment apparatus 900, described above. The second method includes receiving a first message from a communication network, where the first message includes a configuration for logging MBS measurements. The second method includes performing MBS measurements for at least one MBS service of interest in accordance with the received configuration and transmitting a second message to the communication network, where the second message includes a set of logged measurement results for the at least one MBS service of interest.

In some embodiments, performing the MBS measurements comprises switching to an MBS BWP on carrier frequencies and cells which are used to receive the at least one MBS service of interest. In some embodiments, the first message is broadcast by the communication network in system information, where the configuration for logging MBS measurements contains a common configuration. In such embodiments, the second method includes determining whether to apply the received configuration.

In some embodiments, the second method includes receiving an indication from the communication network that allows initiation of RRC connection establishment and/or RRC connection resume for MBS measurement reporting. In such embodiments, transmitting the second message includes establishing an RRC connection for reporting the set of logged measurement results or resuming an RRC connection for reporting the set of logged measurement results.

In certain embodiments, establishing the RRC connection for reporting the set of logged measurement results includes transmitting a setup request message containing a cause value that indicates that the RRC connection is to be established for MBS access. In certain embodiments, resuming the RRC connection for reporting the set of logged measurement results includes transmitting a resume request message containing a cause value that indicates that the RRC connection is to be resumed for MBS access.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method to collect Multicast and Broadcast Service (“MBS”) measurements from a device in a communication network, the method comprising:
transmitting a first message to a communication device, said first message comprising a configuration for logging MBS measurements;
receiving a second message from the communication device, said second message comprising a set of logged measurement results for at least one MBS service of interest; and
controlling MBS operation in the communication network based on the logged measurement results collected from the communication device.

2. The method of claim 1, wherein the first message is a dedicated message sent to the communication device while in a connected mode.

3. The method of claim 1, wherein the first message is broadcast to the communication device in system information, wherein the configuration for logging MBS measurements comprises a common configuration.

4. The method of claim 1, wherein the configuration for logging MBS measurements comprises one or more of: a list of carrier frequencies and cells to measure, a BWP to use for MBS measurement, a list of candidate MBS sessions to measure, a type of MBS measurement, an RRC state in which MBS measurement is to be performed, a logging duration, a logging interval, and a location requirement.

5. The method of claim 1, wherein receiving the second message comprises:
receiving a request message; and
performing one of: establishing an RRC connection for reporting the set of logged measurement results and resuming an RRC connection for reporting the set of logged measurement results.

6. The method of claim 5, wherein establishing the RRC connection for reporting the set of logged measurement results comprises receiving a setup request message containing a cause value that indicates that the RRC connection is to be established for MBS access.

7. The method of claim 5, wherein resuming the RRC connection for reporting the set of logged measurement results comprises receiving a resume request message containing a cause value that indicates that the RRC connection is to be resumed for MBS access.

8. The method of claim 1, wherein the communication network transmits an indication to the communication device that allows establishing an RRC connection for MBS access and/or allows resuming an RRC connection for MBS access.

9. A communication network comprising:
a transmitter that transmits a first message to a communication device, said first message comprising a configuration for logging MBS measurements;
a receiver that receives a second message from the communication device, said second message comprising a set of logged measurement results for at least one MBS service of interest; and
a processor that controls MBS operation in the communication network based on the logged measurement results collected from the communication device.

10. A User Equipment (“UE”) apparatus comprising:
a receiver that receives a first message from a communication network, said first message comprising a configuration for logging MBS measurements;
a processor that performs MBS measurements for at least one MBS service of interest in accordance with the received configuration; and
a transmitter that transmits a second message to the communication network, said second message comprising a set of logged measurement results for the at least one MBS service of interest.

11. The apparatus of claim 10, wherein performing the MBS measurements comprises switching to an MBS BWP on carrier frequencies and cells which are used to receive the at least one MBS service of interest.

12. The apparatus of claim 10,
wherein the receiver further receives an indication from the communication network that allows initiation of RRC connection establishment and/or RRC connection resume for MBS measurement reporting,
wherein transmitting the second message comprises performing one of
establishing an RRC connection for reporting the set of logged measurement results, and
resuming an RRC connection for reporting the set of logged measurement results.

13. The apparatus of claim 12, wherein establishing the RRC connection for reporting the set of logged measurement results comprises transmitting a setup request message containing a cause value that indicates that the RRC connection is to be established for MBS access.

14. The apparatus of claim 12, wherein resuming the RRC connection for reporting the set of logged measurement results comprises transmitting a resume request message containing a cause value that indicates that the RRC connection is to be resumed for MBS access.

15. The apparatus of claim 10, wherein the first message is broadcast by the communication network in system information, wherein the processor determines whether to apply the received configuration, wherein the configuration for logging MBS measurements comprises a common configuration.
